(19) United States
(12) Patent Application Publication
(10) Pub. No.: US 2025/0001226 A1
(43) Pub. Date: Jan. 2, 2025

(54) HANDHELD FIRE EXTINGUISHING EQUIPMENT FOR THE FORMATION OF A TWO-PHASE BUBBLE-STRUCTURED STREAM AND THE METHOD OF EXTINGUISHING

(71) Applicant: Jetex Innovation S.R.O., Jesenice, Osnice (CZ)

(72) Inventors: Igor Alexandrovich Lepeshinsky, Moscow (RU); Radim Snoza, Jesenice, Osnice (CZ); Alexander Anatolyevich Migachev, Moscow (RU); Polina Viktorovna Zotikova, Michaylovka (RU)

(21) Appl. No.: 18/699,003

(22) PCT Filed: Jun. 14, 2022
(86) PCT No.: PCT/CZ2022/000026

§ 371 Date: Apr. 5, 2024

(30) Foreign Application Priority Data
Oct. 6, 2021 (CZ) PV 2021-467

(51) Int. Cl. A62C 31/12

(52) U.S. Cl. CPC A62C 31/12

(57) ABSTRACT

Small and light handheld fire extinguishing equipment with an accumulator battery (4) and a high-pressure water pump (2). The fire extinguishing equipment has a firefighting nozzle (1) suctioning on a regulated basis the outside atmospheric air through first suction orifices (14), using a regulator (13) into a mixing chamber (12), and through second suction orifices (17) into an adapter (9). The mixing chamber (12) is connected on one end to a conical inlet nozzle (19) for the supply of pressurized water from the high-pressure water pump (2), and on the opposite end to an outlet channel (20), linked to an outlet chamber (22), fitted with an outlet partition (23) with outlet orifices (24). The outlet chamber (22) is linked to the outlet channel (20), which has its variable sections symmetrically rotationally aligned to the longitudinal axis (21) of the firefighting nozzle (1). The sections of the outlet channel (20) are selected from a group, including the shapes of a truncated cone, composed truncated cones, rotating ellipsoid, rotating paraboloid and rotating hyperboloid. The two-phase flow of air and water behind the mixing chamber (12) on the inlet into the outlet channel (20) has a volume structure of air with drops of water, where the volume concentration of air is higher than 0.523; the two-phase bubble-structured flow on the outlet from the widened end part of the outlet channel (20) has a volume structure of droplets of water and bubbles of air, where the volume concentration of air is lower than 0.523. The pressure of pressurized water, inletting into the inlet nozzle (19), is 2 MPa. The extinguishing stream on the outlet (7) of adapter (9) of the fire extinguishing equipment has an outlet speed of up to 36 m·s⁻¹ and a reach up to 25 m. The high-pressure water pump (2) at 10 000 revolutions per minute, has a displacement on the outlet (26) from the pump (2) of 1 liter of pressurized water per 1 second at the pressure of 2 MPa and power of the electric engine (3) of 3.5 KW and voltage of 60 V. · this pressurized water suctions on a regulated basis the ambient atmospheric air without pressure through the first suction orifices (14) into the mixing chamber (12), in which air and water get mixed into the mixture of a two-phase flow of air and drops of water: · the obtained stream of air and drops of water behind the mixing chamber (12) gets reformed into a two-phase bubble-structured flow of droplets of water and bubbles of air by passing through the indent sections of outlet elements of the firefighting nozzle (1): where · into the outlet adapter (9) outside air is suctioned on a regulated basis through the outlet orifices (24) of the outlet partition (23); and · the generated two-phase flow of a turbulent character and bubble structure of dispersed drops of sizes 10 to 300 pm comes out of the outlet (7) from the firefighting nozzle (1) of the fire extinguishing equipment to the place of fire at the speed of up to 36 m·s⁻¹ and maximum reach up to 25 m. The high-pressure water pump (2) at 10 000 revolutions per minute, has a displacement on the outlet (26) from the pump (2) of 1 liter of pressurized water per 1 second at the pressure of 2 MPa and power of the electric engine (3) of 3.5 KW and voltage of 60 V.

### TECHNICAL FIELD

The present invention relates to a handheld fire extinguishing equipment for the formation of a two-phase bubble-structured stream which comprises of a firefighting nozzle and high-pressure water pump connected to an electric engine and accumulator battery. The firefighting nozzle is connected through a fire hose to a high-pressure water pump, which is connected to a water source. The firefighting nozzle is equipped with a water chamber with a water inlet, an air chamber with the supply of air and a mixing chamber for mixing of water and air and an outlet adapter with an outlet of the extinguishing mixture.

The present invention also relates to the method of extinguishing in the handheld fire extinguishing equipment for the formation of a two-phase bubble-structured flow, coming out of the outlet of firefighting nozzle of the fire extinguishing equipment. Air and pressurized water are first led into a mixing chamber, and are mixed in the mixing chamber into a two-phase flow of air and droplets of water. The formed two-phase flow of air and water behind the mixing chamber goes through outlet elements with outlet orifices into the ambient environment. In the outlet elements a two-phase bubble-structured stream of droplets of water and bubbles of air is generated, with droplet sizes ranging from 10 to 300 μm, where the volume concentration of air in the mixing chamber is bigger than 0.523.

### PRIOR STATE OF THE ART

Known in the art is the structure of a pneumatic spray nozzle, which has a housing with a nozzle and collector for the supply of liquid and gas [Pazi D. G. Galustov V. S. Basics of the Liquid Spraying Technique. M., Chemie, 1984, page. 254].

The drawbacks of the design are a non-uniform distribution of concentration of air and droplets of water in the cross-sectional area and a high volume flow rate of the gaseous phase.

Another analogous solution is a pneumatic spray nozzle, which has a housing with a nozzle, collector for the supply of liquid and gas and a porous insert permeable to liquid and gas placed in the housing [A. S. 897306, published on 15 Jan. 1982, G. Bazarov, V. I. Birjukov].

The drawbacks of the design are a big hydraulic resistance and complicated mixture regulation, with respect to the concentration, which leads after increasing the liquid content in the mixture to occasional fluctuations in the operation.

An equipment the technological principle of which is close to the designed equipment is the fire extinguishing equipment under patent application CZ PV 2021-29 (priority 10 Apr. 2020 RU) and corresponding international patent application PCT/CZ2021/000004 of the same applicant. A mixing chamber for the generation of a high-speed two-phase dispersed bubble-structured stream is manufactured in the form of block of mixers with a front partition and rear partition, in between which tube mixers are placed. The inlet orifice of each mixer has a confusor connected with a chamber for the supply of water. Tube mixers are fitted from the side of the rear partition with side orifices and the opposite sides of mixes are fitted with diffusors. Outlet ends of the diffusors with gaps are placed in the orifices of the front partition. For the specified flow rate of water, the number of mixers has been defined based on the flow rate of air. On the outlet from the firefighting nozzle, the high-speed dispersed stream has droplets with sizes ranging from 100 to 300 μm. The firefighting nozzle is connected with the compressor of a gas-turbine engine. The firefighting nozzle has a mixing chamber, divided by partitions to a chamber for the supply of water, chamber for the supply of air and dispersing chamber. The dispersing chamber narrows into a gas-dynamic propelling nozzle from which a high-speed dispersed stream comes out. The firefighting nozzle is connected with a rotating mechanism which can rotate it vertically and horizontally. The control unit is fitted with a remote control and connected to an electro generator.

It is an efficient, large and robust fire extinguishing equipment, produced for instance as a 6-meter-long serial container. It is designated for a big reach of the extinguishing stream, up to 120 meters vertically and up to 80 meters horizontally. This is necessary for extinguishing big and extreme fires with high thermal radiation intensity, combined with a great difficulty involved in extinguishing, such as extinguishing forest fires, extinguishing oil slicks, extinguishing facilities with increased radiation, extinguishing fires on construction sites and in multistory buildings, when the facility has a poor accessibility, such as in case of a road blockage, in chemical plants and many others. The fire extinguishing equipment works with compressed air or gas obtained through the compressor of a gas-turbine engine.

This is matched in the complexity of design and robustness of the fire extinguishing equipment, requiring not only pressurized water but also a separate inlet of a larger quantity of compressed air, which makes the fire extinguishing equipment excessive in size and weight as a result.

Known and widespread is a handheld fire extinguishing equipment or, respectively firefighting nozzles for extinguishing smaller fires, such as by ROSENBAUER. These firefighting nozzles use only water for the extinguishing. The firefighting nozzle can generate up to three modes: direct stream, water mist and, as the case may be, water curtain. No air supply ever required.

To this end, a high pressure of extinguishing water must be applied for the water to disperse into the smallest droplets possible. To this end high-performance pumps are used in combination with diesel aggregates for water suction. Such devices are relatively voluminous and relatively very heavy, up to 150 kg, therefore mostly non-portable. The firefighting nozzle itself is light, about 2 kg or more. As far as the pressurized water from water pump is concerned, pressure up to 15 MPa has been stated.

Patent application CN 10 63 90 343 A (published on 15 Feb. 2017) describes air suction into a dual dual-purpose nozzle which is able to combine the extinguishing system of water fog suction and a foam extinguishing system. The design uses pressurized water and air suction. From this mixture, a fog of tiny droplets of water with air is generated. Air is sucked through suction orifices 5, placed on the perimeter of the outer wall of the nozzle tube 4 in its upper part. On the outer side of the nozzle tube 4 is an air cavity for the communication with suction orifices 5. Under the nozzle tube 4 a gasification chamber 6 is situated, whose upper part is fitted with an orifice connected with the nozzle tube 4 and whose lower part is fitted with a nozzle 7 for dispersing a fine water fog or foam. Under the dispersing nozzle 7 an impact spring 8 of a conic shape is situated, narrowing in the direction of dispersing, the length of which can be controlled by screws 10. It is stated in the description that working pressure of the multi-purpose nozzle is 0.6 to 1.2 MPa, flow rate of water is 25 to 33 liters per minute, and the sizes of droplets in the fine water fog are 0.99 to 300 μm. The angle of dispersion can be set by screws by adjusting the spring 8, from which the fine water for or foam medium comes out to cover the place of fire. The reach of extinguishing medium is not stated. It is mentioned in the description that the fire extinguishing equipment is of a great significance to special extinguishing, such as the extinguishing of fires on ships. Considering that the final stream of extinguishing medium is controlled from the orifices of conic spring manually by a screw/screws, manual extinguishing can be assumed. There is a recommendation in the description: extinguish by water fog first and then add a foam solution which foams, covers the surface of fire and isolates the source of fire from air.

The drawback of this firefighting nozzle is the described regulation of extinguishing stream by handling a screw placed behind the spring 8, from which the stream of extinguishing medium for the extinguishing of fire comes out. Handling the screws placed behind the spring, such as when regulating the spring compression, is difficult to imagine to be done during extinguishing. It is likely that the firefighting nozzle is difficult to direct in the direction of fire or at a smaller distance or height.

Most analogous to the present design is patent RU 2 656 033 C1 named “Mixer with a Two-Phase Working Medium” (date of publication granted 30 May 2018). A mixer is claimed which comprises of a cylindrical mixing chamber with an inlet nozzle for the supply of liquid, fitted with orifices in the body of the mixing chamber and having an outlet device for two-phase flow with channels for the outlet of a two-phase stream of the extinguishing mixture. The orifices in the body of mixing chamber are placed perpendicularly to the axis of mixing chamber. The channels of outlet device are cylindrically shaped and are 1 to 10 mm long and are placed parallel to the axis of mixing chamber or under an angle up to 60° to the axis of mixing chamber. Volume concentration of gas in the mixing chamber must not be less than 0.5. It is stated in the description that the diameter of cylindrical chamber and the length of mixing chamber are selected for the volume concentration of gas in order to correspond to the mode of a gas droplet in a two-phase flow, i.e. to be bigger than 0.5, more accurately to be 0.523, where this value defines the permissible value of volume concentration. For this value of permissible volume concentration of gas (air) of 0.523, detailed theoretical calculation and formulas based on the laws of liquid and gas mechanics are provided in the patent description.

The permissible volume concentration of gas in the mixing chamber was determined theoretically at a value bigger than 0.523. No quantitative values, such as the pressure of supplied water and air, speed of outlet extinguishing mixture, reach of outlet mixture etc. are specified in the patent. We can therefore expect that the equipment has not been sufficiently tested.

### SUMMARY OF THE INVENTION

The said drawbacks are removed or significantly limited in case of the handheld fire extinguishing equipment, which includes a firefighting nozzle, a high-pressure water pump, connected to an electric engine and accumulator battery, where the firefighting nozzle is connected by a fire hose to the high-pressure water pump, which is connected to a water source, the firefighting nozzle is fitted with a water chamber with a water inlet, an air chamber with an air supply and a mixing chamber for the mixing of water and air and an adapter with an outlet of the extinguishing mixture, which is two-phase bubble-drop stream.

The subject matter of the present invention is based on the fact, that the firefighting nozzle has
the first suction orifices, arranged along the perimeter of the mixing chamber, for the supply of outside atmospheric air into the mixing chamber, are connected through the regulator of suctioned outside air to the air chamber, connected to the mixing chamber;
at least one second suction orifice for the supply of outside atmospheric air into the adapter is situated along the perimeter of screw fitting of the adapter or along the perimeter on the adapter immediately behind the outlet partition of the water chamber;
the mixing chamber, connected on one end to a conical inlet nozzle, narrowing in the direction of the flow and connected through the chamber to a water inlet, and on the other end, the mixing chamber is connected to an outlet channel, linked to an outlet chamber; and
the outlet chamber fitted with, perpendicular to the direction of longitudinal axis of the firefighting nozzle, an outlet partition with outlet orifices.

The main advantage of this invention is the attainment of a small and light handheld fire extinguishing equipment, which owing to its overall structure enables the claimed change of volume concentration of the bubbles of air and drops of water for the generation of an extinguishing two-phase bubble-structured stream. The given change of volume concentration, which separates the mode of droplets of water from the mode of air bubbles is provided namely by the structure of gas-dynamic firefighting nozzle according to the present invention and the linked to components of the fire extinguishing equipment, such as a high-pressure pump and accumulator battery with an electric engine. An important advantage of the invention is the generation of a determined field of volume concentration by means of generating a changing structure of the flow during the process of generation of the two-phase bubble-structured stream, which has similar properties to a water jet.

The structure of the handheld fire extinguishing equipment according to the present invention provides for the attainment of a strong, intensive and direct extinguishing two-phase bubble-structured stream, which is forcible enough to be aimed straight at place of fire for the required distance and in a short time.

A significant advantage of the present invention is the attainment of a handheld fire extinguishing equipment with a low weight up to 50 kg, including the high-pressure water pump, electric engine and accumulator battery. The fire extinguishing equipment as a whole, i.e. including the high-pressure water pump, electric engine and accumulator battery has small dimensions, size of a larger shopping bag, about 70×40×25 cm. The length of the firefighting nozzle is about 60 cm, its biggest diameter lengthwise is about 8 cm, the diameter if viewed from above is about 8 cm. The internal diameter of water chamber is about 25 mm and of the outlet adapter about 15 mm. The internal diameter of the inlet water nozzle, mixing chamber, outlet channel and outlet chamber ranges from about 20 mm to 5 mm. From the above-mentioned it is clear that the handheld fire extinguishing equipment according to the present invention is easily portable.

Another big advantage is that it is easy to operate even for untrained personnel.

Surprisingly, this handheld fire extinguishing equipment allows for working with the ambient atmospheric air, without pressure. The ambient air is suctioned in through suction orifices, the first and second suction orifices, where the volume of air is regulated as necessary. The first suction orifices suction the ambient air into the mixing chamber. The second suction orifices serve for significantly increasing the speed and pressure of the final outlet extinguishing mixture from the outlet of the outlet adapter. The second suction orifices may be arranged either along the perimeter of screw fitting of the adapter or in the immediate proximity behind the outlet partition of the water chamber, which depends on the particular structural adaptation of the firefighting nozzle. An important part of the firefighting nozzle is the mixing chamber, in which the incoming air and pressurized water are mixed in the required proportion to generate a two-phase gas-dynamic stream of the extinguishing mixture. The water chamber serves for the generation of a sufficient supply of pressurized water and provides for the stability of pressure for the required volume of water. In the conic-shaped inlet nozzle before the mixing chamber, speed and water pressure get stabilized. In the outlet chamber and the linked outlet channel, a two-phase gas-dynamic stream of the extinguishing mixture is formed. The outlet orifices of the outlet partition in the end of the outlet chamber are in fact functional nozzles, which generate bigger pressure and channel the jets of final extinguishing mixture on the outlet from the fire extinguishing equipment.

It is advantageous when the first suction orifices are placed in the mixing chamber, are shaped as small cylindrical channels, are placed perpendicularly to the longitudinal axis of the firefighting nozzle (and mixing chamber) and are linked to the air chamber, which is connected to the regulation orifice of the regulator, placed in the housing of the firefighting nozzle. The advantage of the first suction orifices is the intake of a regulated volume of air using the regulator into the mixing chamber, without having to use pressurized air. The small cylindrical channels of the first suction orifices work as a nozzle of intake air, which saturate the pressurized stream of water.

It is also advantageous, when the outlet channel has a variable section arranged symmetrically and rotationally to the longitudinal axis of the firefighting nozzle, where the section of outlet channel is selected from the group which includes the shapes of a truncated cone, compound truncated cones, rotating ellipsoid, rotating paraboloid and rotating hyperboloid. Many types of outlet channels have been designed, some alternative embodiments of which are presented in the example embodiments and discussed in detail there. The most advantageous proved the shapes of a hyperboloid and compound truncated cones.

It is also advantageous, when the outlet channel is extended in the direction of flow, which proved beneficial for a significant increase in pressure and speed of the passing-through stream of the extinguishing mixture.

It is also advantageous, when the outlet chamber is cylindrical or conically narrowing in the direction of flow. An outlet chamber of a cylindrical shape is easy to manufacture and keeps the pressure of passing-through stream constant. The outlet chamber, narrowing slightly conically, slightly increases the pressure and speed of the flowing mixture.

It is also advantageous, when the outlet partition is planar, its outlet orifices have a cylindrical shape and are oriented in the direction of longitudinal axis of the firefighting nozzle. Or when the outlet partition is convex, its outlet orifices have a cylindrical shape and are beveled to the longitudinal axis of the firefighting nozzle, with the advantage being around 30°. The stream of extinguishing mixture will be formed in the outlet orifices of outlet partitions into jet streams, which will form a two-phase gas-dynamic stream. The planar outlet partition serves for the production of lighter extinguishing mixtures. The slightly convex outlet partition is designated for the production of heavier extinguishing mixtures.

For the handheld fire extinguishing equipment according to the present invention the applicant developed a special high-pressure multistage water pump according to the present invention. The tested pump is three-stage. It is fitted with turbine blade wheels rotating around their axis, arranged one after another in the direction of rotating shaft of the pump and fitted with separated firmly fixed spiral blades radially arranged to the shaft axis. According to the present invention the blades have a different shape and a different angle of attack each and are designed as a combination of partly open and partly closed blade wheels. The advantage of this design of blades and blade wheels is the potentiality of attaining high pressure and flow rate through the pump at a relatively low power of the electric engine. From this reason another big advantage of this high-pressure water pump ensues, in the form of its low weight up to 14 kg and a very simple intuitive operation even for untrained operators of fire extinguishing equipment. The low weight and relatively small size make the handling and mobility of this type of high-pressure water pump connected to a handheld firefighting nozzle easier.

In the most advantageous and tested embodiment according to the present invention, the high-pressure water pump has at 10 000 revolutions per minute, displacement on the outlet from the high-pressure water pump of 1 liter of pressurized water per 1 second at the pressure of 2 MPa and power of the electric engine of 3.5 kW and voltage of 60 V.

The invention also relates to the method of extinguishing in a handheld extinguishing equipment for the formation of a two-phase bubble-structured flow according to claims 1 to 9 of the present invention. The principle of the extinguishing method consists in, that the two-phase flow of air and water behind the mixing chamber on the inlet into the outlet channel has a volume structure of drops of water and air, where the volume concentration of air must be bigger than 0.523. And vice versa, the two-phase bubble-structured flow on the outlet from the widened end part of the outlet channel has a volume structure of droplets of water and bubbles of air, where the volume concentration of air must be lower than 0.523. Thus, the values of volume concentration of air>0.523 define the existence of flow of bubbles of air and drops of water. And the values of volume concentration of air<0.523 define the existence of a two-phase bubble-structured flow, which has similar properties as a water jet. After the impact on the place of fire a large quantity of steam is generated, absorbing oxygen, thus accelerating the extinguishing process. Keeping the claimed permissible volume concentration in the given spots of the firefighting nozzle is essential for the generation of a two-phase bubble-structured stream and its speed on the outlet. For sake of completeness, volume concentration is defined as the volume of a component divided by the volume of a mixture, where if dimensionless, the mixture unit is 1; and it is expressed as a number, in this case 0.523 (or 52.3% of 100%). If one component of the mixture has volume concentration of 0.523, the second component has volume concentration of 0.477.

The main advantage of the extinguishing method according to the present invention is, that in a small handheld extinguishing equipment the resulting extinguishing high-speed two-phase bubble-structured stream of bubbles of air with a finely dispersed structure of droplets of water is attained, and with the given claimed volume concentration of both phases, gaseous and liquid. In the small handheld extinguishing equipment, conditions from large extinguishing equipment were applied from theoretical calculations of volume concentration of air, and were further developed, specified, improved and tested. The structure of fire extinguishing equipment according to the present invention facilitates the said change of volume concentration in indented sections of the outlet parts of the firefighting nozzle, in particular in the outlet channel behind the mixing chamber of firefighting nozzle. The extinguishing two-phase bubble-structured stream according to the present invention with the required reach and linear trajectory provides a short extinguishing time and consumes a small quantity of water. As far as we know, known patents due to their documented mechanical structure eliminate the possibility of generating a two-phase gas-dynamic bubble-structured stream in small handheld firefighting nozzles. Water or liquid foaming agents are used similarly on a separate basis, but it is impossible to provide for a fine dispersion and reach of the extinguishing stream to very short and medium-length distances in interiors and exteriors.

For the extinguishing method in the fire extinguishing equipment according to the present invention, it is advantageous when:
from the high-pressure water pump pressurized water under pressure of 2 MPa±0.3 MPa and in the quantity of 60±15 liters per minute is led into the convergent conical nozzle and from there into the mixing chamber on a regulated basis;
   the pressurized water suctions on a regulated basis the ambient atmospheric air without pressure through the first suction orifices into the mixing chamber, in which air and water get mixed into the mixture of a two-phase flow of air and drops of water;
   the obtained stream of air and drops of water behind the mixing chamber is reformed into a two-phase bubble-structured flow of bubbles of air and droplets of water by the passage through the indented sections of outlet elements of the firefighting nozzle; where
   into the outlet adapter outside air is suctioned on a regulated basis through the outlet orifices of outlet partition and
   the generated two-phase flow of turbulent character and bubble structure of dispersed drops and bubbles of air, with drops sizes 10 to 300 μm comes out from the outlet of firefighting nozzle of the fire extinguishing equipment into the place of fire at the speed of up to 36 m·s⁻¹ and with maximum reach up to 25 m.

Regulated pressurized water, in the claimed range of pressure of 2 MPa±0.3 MPa and quantity of 60±15 liters per minute, satisfies the inlet condition for generation of the resulting two-phase bubble-structured stream. This method of extinguishing uses suction of ambient air without pressure on a regulated basis, both through the first suction orifices into the mixing chamber, and through the second suction orifices into the adapter of firefighting nozzle. Because the outside atmospheric air is used, it is not necessary to supply pressurized air through voluminous compressors or a large number of pressure cylinders. Ambient air is suctioned in through at least one regulation orifice of at least one regulator through the air chamber through the first suction orifices into the mixing chamber, in which air and water get mixed into the mixture of a two-phase flow of bubbles of air and drops of water. The obtained stream further proceeds into the outlet channel with a bigger section in the end, in which the mixing of particles of water and air increases. From the outlet channel the stream further proceeds into the outlet chamber and on its end it passes through the outlet orifices of outlet partition into the outlet adapter with regulated intake of ambient air, e.g., through the rotating screw fitting on the adapter. In these outlet elements the flow gets decelerated while pressure and density of air get increased, whereby the volume filled by the air gets reduced and the flow converts into the bubble structure of dispersed drops of water and bubbles of air with drops sizes 10 to 300 μm. The generated two-phase bubble-structured flow of a turbulent character comes out of the outlet from the fire hose of the fire extinguishing equipment into the place of fire at the speed up to 36 m·s⁻¹ and with maximum reach up to 25 m.

### OVERVIEW OF THE FIGURES IN DRAWINGS

The invention is described in detail below in nonrestrictive example embodiments and explained in the attached drawings, where:

FIG. 1 shows a block scheme of the handheld fire extinguishing equipment with a high-pressure water pump and electric engine;

FIG. 2 shows a view from above of the firefighting nozzle;

FIG. 3 shows a side view of the firefighting nozzle with a handle in the resting position;

FIG. 4 shows a section A-A from FIG. 3, perpendicular to the longitudinal axis of the firefighting nozzle, with a handle in the working position, with a conus channel widening in the direction of flow, shown by arrows;

FIG. 5.1 shows a vertical section, perpendicular to the longitudinal axis of the firefighting nozzle, with an alternative conus outlet channel;

FIG. 5.2 shows a vertical section of the firefighting nozzle with an alternative outlet channel in the shape of a rotating assembled hyperboloid;

FIG. 5.3 shows a vertical section of the firefighting nozzle with an alternative rotating ellipsoid outlet channel;

FIG. 5.4 shows a vertical section of the firefighting nozzle with an alternative outlet channel in the shape of a simple rotating hyperboloid;

FIG. 5.5 shows a vertical section of the firefighting nozzle with an alternative outlet channel in the shape of a simple rotating hyperboloid;

FIG. 6 shows an axonometric side view of the high-pressure water pump with the supply of water from the water source on the right;

FIG. 7 shows an axonometric side view of the high-pressure water pump with the supply of water from the water source on the left;

FIG. 8 shows the first blade wheel of the high-pressure water pump in section B-B from FIG. 6;

FIG. 9 shows a visual view through the high-pressure water pump orifice on the side of supply of water from FIG. 6; and

FIG. 10 shows a vertical longitudinal section C-C from FIG. 7.

### EXAMPLES OF THE INVENTION EMBODIMENT

The method of extinguishing and the fire extinguishing equipment according to the present invention resolve the drawbacks of present extinguishing systems.

The present systems based on the use of liquid nozzles have several important drawbacks. When extinguishing a fire, it needs to be ensured that
i) the flame is shrunk, which requires a high speed of the extinguishing stream;
ii) the heat is led away by evaporating water;
iii) oxygen from the air is removed by steam generated from water.

In the present systems, extinguishing streams have usually low speeds and, therefore, even if they can reach the place of fire, they usually do not satisfy the requirement of shrinking the flame. For water to evaporate quickly, it must be pulverized into droplets. Liquid jet in pulverization gives large droplets in the order of magnitude 1 000 to 5 000 μm. Drops of liquid/water are required in the order of magnitude 150 to 300 μm. In this case, the evaporation speed increases˜ 1000 times. The result is that the stream has a ballistic trajectory and droplets fall on the ground in front of the source of fire, without being evaporated. Moreover, the short reach of a liquid jet where the radiation intensity is high does not allow for extinguishing most fires at all or, respectively, it is often very difficult and takes long. The result is that during the extinguishing a large quantity of water gets wasted, thus damage from the extinguishing often exceeds damage caused by the fire alone.

Therefore, a new technology was developed for the generation of extinguishing streams according to the present invention without these drawbacks. The principle of this new extinguishing system lies in the formation of a high-speed two-phase stream of bubbles of gas/air with finely dispersed composition of droplets of liquid/water, and with a certain concentration of both phases, gaseous and liquid in the given extinguishing equipment. The extinguishing two-phase bubble-structured stream according to the present invention has a long range/reach, linear trajectory, short time of extinguishing and consumes a small quantity of water. The new fire extinguishing equipment according to the present invention serves for the realization of the subject matter of invention, which lies in the change of volume concentration of gas/air and drops of liquid/water behind the mixing chamber 12 in the outlet channel 20 and the generation of a two-phase bubble-structured stream.

The output channel 20 can be implemented in various exemplary embodiments described in detail below, in which the outlet channel 20 is specifically shaped from one to four stages (marked as 20a-20m): 20a, 20b, 20c for Example 1; 20d for Example 2; 20e, 20f, 20g, 20h for Example 3; 20i for Example 4; 20j, 20k, 20l for Example 5; 20m for Example 6.

### Example 1

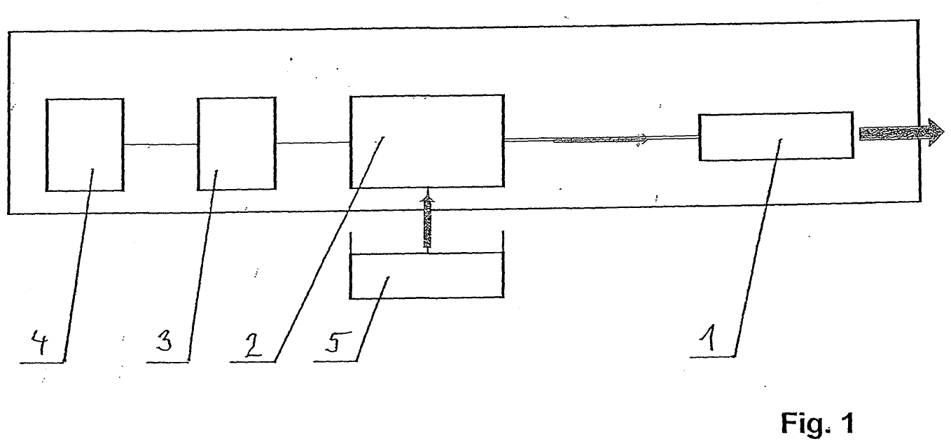

### (FIGS. 1, 2, 3, 4)

Handheld Fire Extinguishing Equipment with a Firefighting Nozzle 1, Having a Three-Stage Shaped Outlet Channel 20

FIG. 1 schematically shows a block scheme of a handheld fire extinguishing equipment. The handheld fire extinguishing equipment includes a firefighting nozzle 1, which is connected by a fire hose to a high-pressure water pump 2 connected to an electric engine 3 driven by an accumulator battery 4. Into the high-pressure water pump 2 a water from the water source 5 is led.

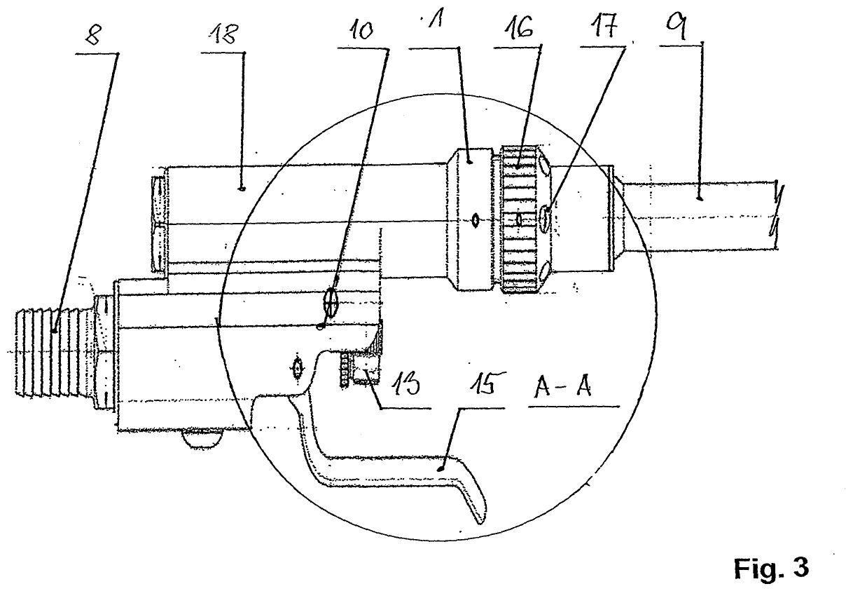

FIG. 2 shows a view from above of the firefighting nozzle 1, where the inlet 6 of water into the firefighting nozzle 1 is marked by an arrow on the left and the outlet 7 of prepared extinguishing mixture from the firefighting nozzle 1 is marked by an arrow on the right. Viewed left from the inlet of water, a screw fitting 8 is marked for the connection of an unshown fire hose. On the opposite end of the firefighting nozzle 1 an adapter 9 is situated, from which the outlet 7 of prepared extinguishing mixture comes out. Between the screw fitting 8 and adapter 9 the housing 10 of the firefighting nozzle 1 is visible, inside of which a water chamber 18 (not shown) is situated in the direction of flow, linked to the mixing chamber 12 (not shown).

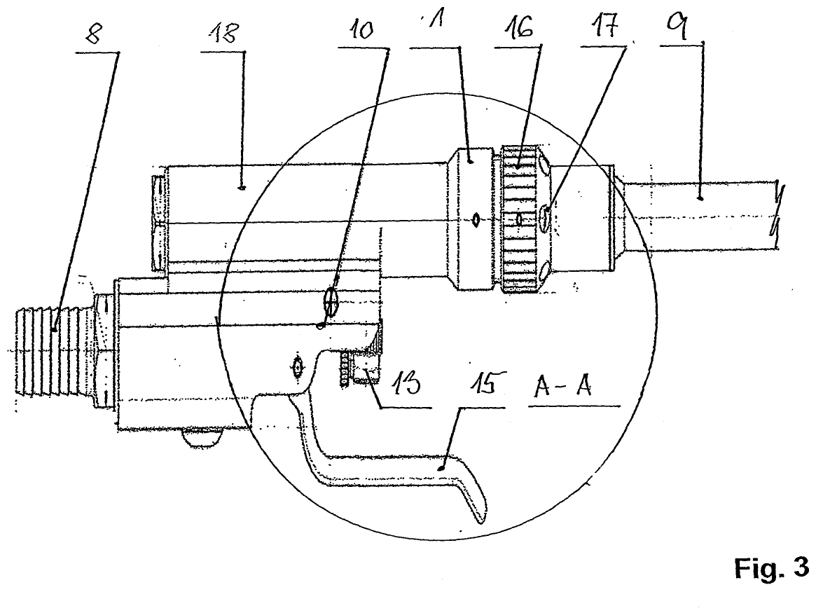

FIG. 3 is a side view of the firefighting nozzle 1 from FIG. 2. On FIG. 3 are shown the screw fitting 8, housing 10 of the firefighting nozzle 1 and the linked adapter 9. In the lower part of the firefighting nozzle 1 a regulator 13 is situated for the regulation of the intake of outside air through first suction orifices 14 (not shown) placed in the mixing chamber 12 (not shown). Under the water chamber 18 a control handle 15 in the extreme restring position is placed. The adapter 9 is fitted with a screw fitting 16 for the connection to the housing 10 of firefighting nozzle 1. In the screw fitting 16 second suction orifices 17 are situated for the intake of outside air into the adapter 9 to the prepared extinguishing mixture.

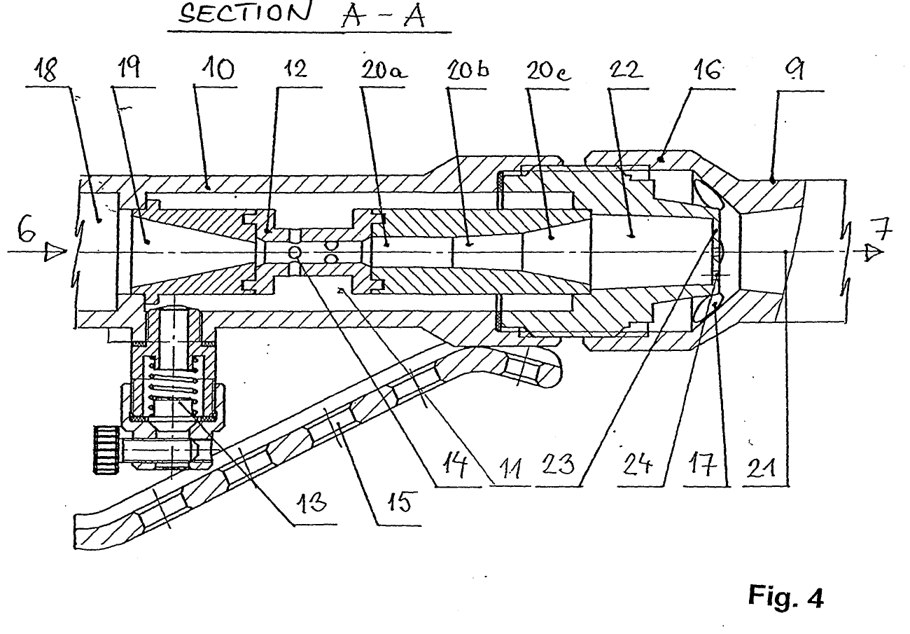

FIG. 4 shows a vertical section through the firefighting nozzle 1 from FIG. 3 with a control handle 15 in the working position. A water inlet 6 is linked to a cylindrical water chamber 18 linked to a narrowing cone-shaped water nozzle 19, mouthing into a cylindrical mixing chamber 12, fitted with first suction orifices 14 for the intake of outside air through an air chamber 11 into a mixing chamber 12. In the mixing chamber 12 water and outside air get mixed into a mixture of air and droplets of water. The mixing chamber 12 is linked to an outlet channel 20.

In this example embodiment the outlet channel 20 can be described as composed, mostly widening in the direction of flow, divided into three stages 20a, 20b, 20c with different sections along the length of the longitudinal axis 21 of the firefighting nozzle 1. The first stage 20a of the outlet channel 20 is cylindrical and is linked on one end to the mixing chamber 12 and on its second end to a second cone-shaped stage 20b of the outlet channel 20. The second cone-shaped stage 20b gets slightly widened by about 10° in the direction of flow. The second stage of the outlet channel 20b is linked to the third cone-shaped stage 20c, widening at a bigger angle of about 30° in the direction of flow.

The outlet channel 20 is linked to a cylindrical outlet chamber 22, which is ended across the entire section by an outlet partition 23, which can be either planar or very slightly convex in the direction of flow. The outlet partition 23 is fitted with outlet orifices 24 in the shape of cylindrical nozzles. The outlet orifices 24 can be situated in the direction of longitudinal axis 21 of the firefighting nozzle in a planar partition 23. Or the cylindrical orifices 24 can be beveled under a certain angle to the longitudinal axis 21 of the firefighting nozzle 1, e.g. under the angle of 3°. Numbers and bevel angles of the outlet orifices of outlet orifices 24 depend on the design intent, the purpose for which the equipment is designed and how it will be used next.

The equipment works as follows and similarly for all types of the below-mentioned extinguishing equipment in the particular example embodiments.

When extinguishing the fire, the operator will connect by a standard fire hose the firefighting nozzle 1 to the high-pressure water pump 2.

The high-pressure water pump 2 (FIG. 1) pumps in water from a water source 5, such as from a lake or reservoir or the pump 2 is connected to a water source 5 from the water main. The high-pressure water pump 2 is driven by an electric engine 3, which is fed from an accumulator battery 4. Water from the high-pressure water pump 2, is pumped through the discharge 26 from the high-pressure water pump 2 connected by an unshown fire hose with the screw fitting 8 (FIG. 2,3) of the firefighting nozzle 1 into its inlet 6.

The fire extinguishing equipment with the manual control handle 15 in the resting position is shown on FIG. 3 and in the working position on FIG. 4.

The mode of operation of the fire extinguishing equipment is further explained and described in detail on FIG. 4 of the firefighting nozzle 1.

Pressurized water is upon turning on by the control handle 15 pumped into the water chamber 18 and proceeds through the inlet nozzle 19 into the mixing chamber 12, placed in the housing 10 of firefighting nozzle 1.

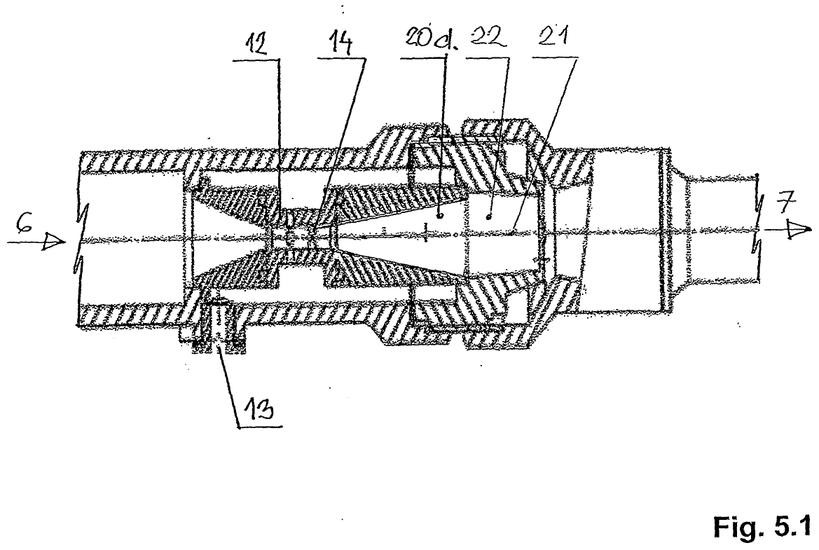

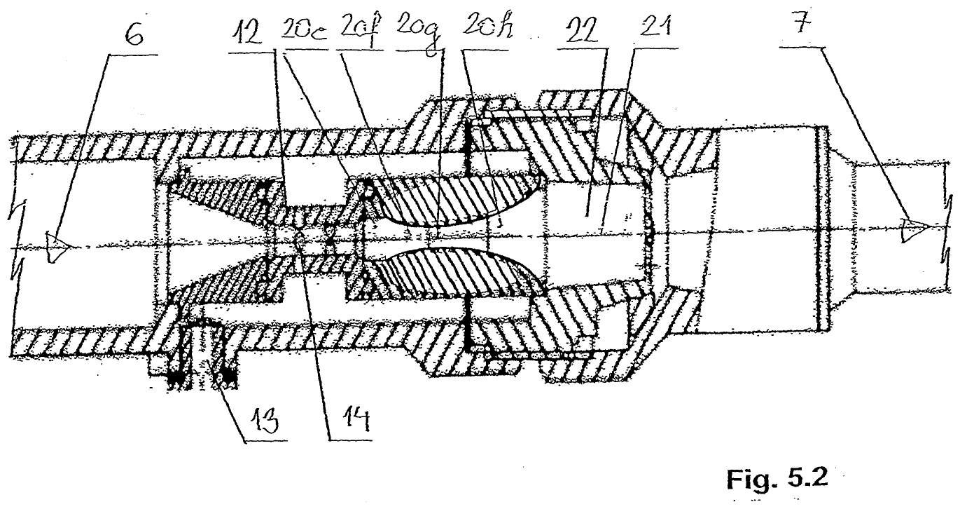

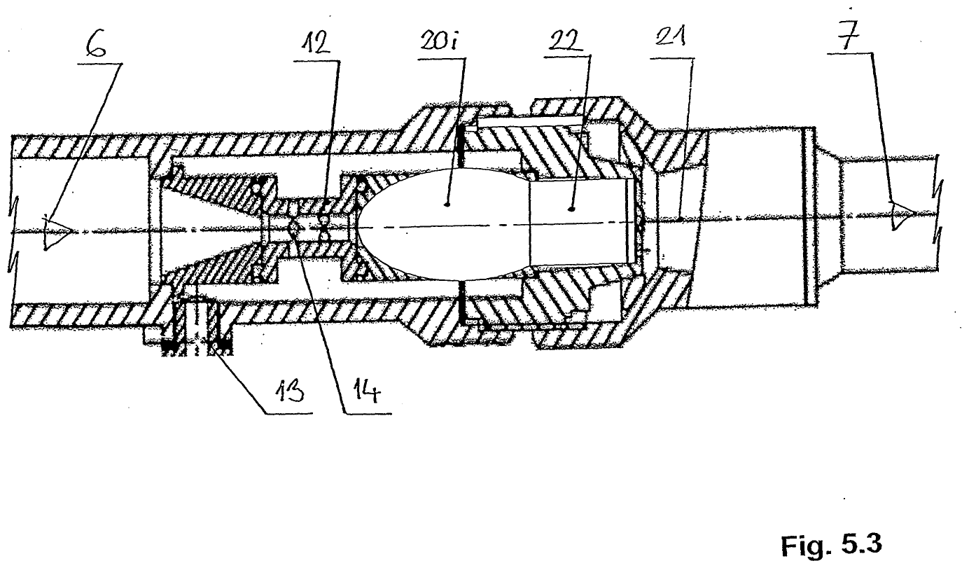

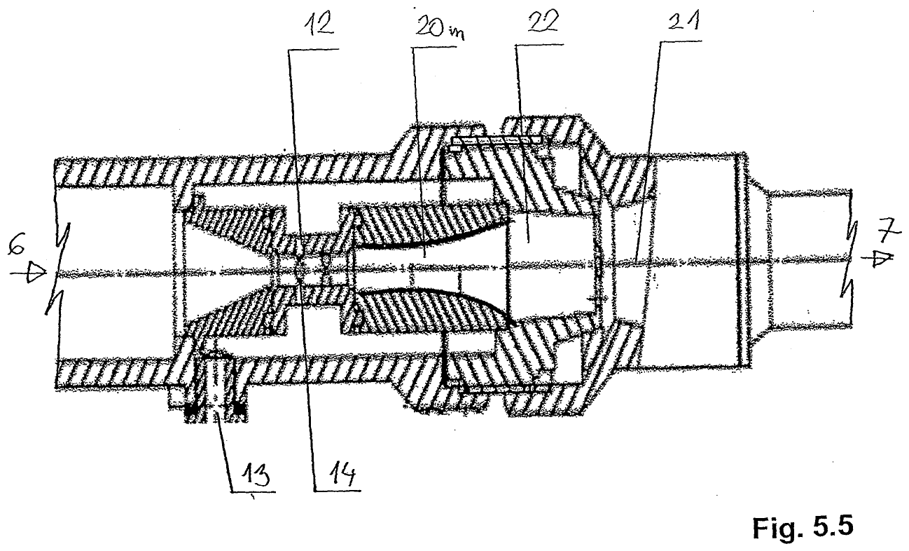

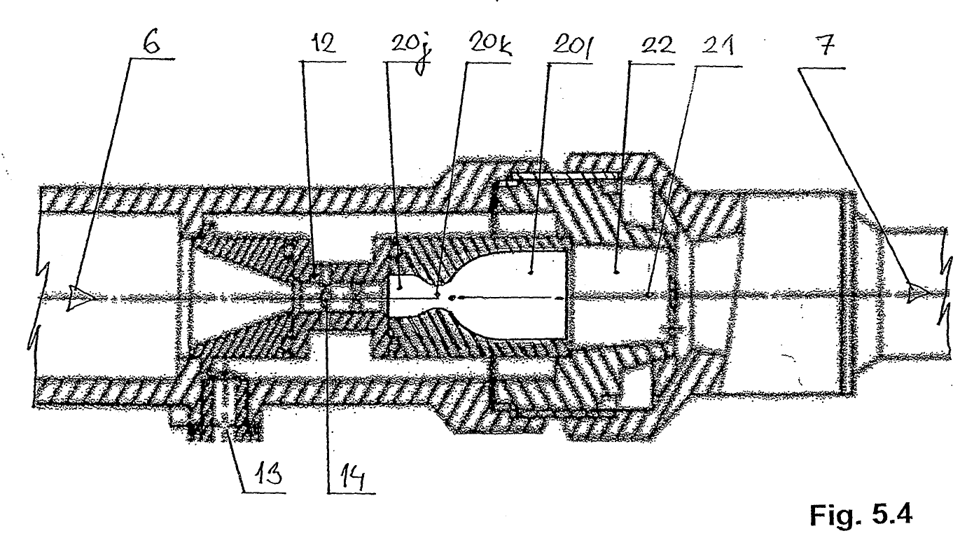

Air is added into the air chamber 11 by a regulator 13 for the intake of ambient atmospheric pressure. The regulator 13 controls the quantity of air suctioned into the air chamber 11. This way, the quantity of air suctioned from the air chamber 11 into the first suction orifices 14 in the linked mixing chamber 12 is regulated. The suction orifices 14 placed in the mixing chamber 12 have the shapes of small cylindrical channels, are placed perpendicularly to the longitudinal axis 21 of the firefighting nozzle 1 and mouth into the air chamber 11 connected with the regulation orifice of the regulator 13, as visible on FIGS. 5.1, 5.2, 5.3, 5.4 and 5.5. By the regulator 13 the intake of ambient air either closes or opens as necessary, thereby changing as necessary the volume flow rate of outside atmospheric air led into the mixing chamber 12 for the purpose of forming a stream, having the structure of bubbles of air with drops of water. The quantity of intake of outside air into the mixing chamber 12 gets regulated e.g. according to the required outlet speed of the two-phase bubble-structured stream on the outlet 7, which is measured by laser. If this required speed is not proper, the intake quantity gets regulated by the regulator 13.

To obtain the resulting final effect of generating a finely dispersed gas-dynamic two-phase extinguishing outlet stream 7 on the outlet from the adapter 9, accurate required values must be reached in the mixing chamber 12 and then in the outlet channel 20, where a two-phase bubble-structured mixture of the working medium, i.e. water and air gets generated.

Widening cone-shaped parts 20a, 20b, 20c of the outlet channel 20 serve for the formation of bubble structure of the flow. The outlet channel 20 due to its widening decelerates the flow, whereby the pressure and density of air increase. This way the volume filled by air decreases and the flow structure changes to a bubble structure. By using a bubble structure of the flow to generate the stream of bubbles of air with droplets of water a very efficient extinguishing stream coming out of the adapter 9 is generated.

In the mixing chamber 12 droplets of pressurized water and bubbles of air get mixed and a mixture is formed, which proceedings from the mixing chamber 12 through the outlet channel 20 into the outlet chamber 22, through which it further passes and proceedings through the outlet orifices 24 of the outlet partition 23.

Then, the extinguishing mixture proceeds from the outlet orifices 24 of the partition 23 into the adapter 9, screwed on the housing 10 of firefighting nozzle 1, by a screw fitting 16 of adapter 9 (FIG. 2, 3, 4). In the example embodiment the screw fitting 16 is fitted with second suction orifices 17 for the intake of ambient atmospheric air into the adapter 9 to the extinguishing mixture. By rotating the screw fitting 16 of adapter 9 (the air intake into the adapter 9 is regulated. Regulation of the quantity of intake of air into the adapter 9 is made e.g., when the resulting two-phase bubble-structured stream, coming out of the adapter 9, is dispersed and does not generate an intensive direct stream for direct extinguishing. Then the quantity of intake of air into the adapter 9 is regulated until a strong, direct and intensive two-phase bubble-structured stream is generated. The suctioned air increases the outlet speed, pressure and reach of the final, finely dispersed two-phase gas-dynamic extinguishing stream on the outlet 7 and of aerosols in a wide range of sizes of droplets of water ranging from 10 to 300 μm in the extinguishing mixture.

The resulting extinguishing two-phase bubble-structured stream on the outlet Z of the exhausting mixture, comes out of the adapter 9 of firefighting nozzle 1 of the fire extinguishing equipment. The operator will direct the adapter 9 with the exiting extinguishing stream Z into the direction of fire.

It can be said, that the flow in the firefighting nozzle 1 has in fact mostly rectilinear direction in the direction of longitudinal axis 21 of the firefighting nozzle 1.

When extinguishing a fire by the handheld extinguishing equipment according to this example embodiment of the invention it has the following tested parameters. Pressurized water, coming out of the high-pressure water pump 2 according to the present invention and inletting through the inlet 6 of water into the inlet nozzle 19 of the firefighting nozzle 1, has pressure of 2 MPa. The prepared extinguishing mixture, coming out of adapter 9, has an outlet speed of 25 m·s⁻¹ and a maximum reach of about 20 m. In this example embodiment it is a light extinguishing mixture.

Light extinguishing mixtures are designated in particular for the extinguishing of fires in interiors, offices, apartments, hotels, where there is an increased need that the extinguishing medium contains as little water as possible. This particular example embodiment ranks as the second most efficient handheld fire extinguishing equipment according to the present invention.

### Example 2

### (FIG. 5.1)

Handheld Fire Extinguishing Equipment with a Firefighting Nozzle 1, Having a Simple Cone-Shaped Outlet Channel 20

FIG. 5.1 shows a firefighting nozzle 1 identical with the previous example 1 (FIG. 4), except for the outlet channel 20 in an alternative structural embodiment of a smooth truncated cone 20d, widening in the direction of flow by about 16° to the longitudinal axis 21 of the firefighting nozzle 1.

Fire extinguishing equipment according to this example embodiment works similarly like in the previous example embodiment, where the shape of a simple truncated cone 20d as an alternative outlet channel 20 is not as efficient as in the previous example embodiment, as shown by following practical tests. In the alternative outlet channel 20 the outlet of extinguishing mixture is formed into the required quality of a light extinguishing mixture.

When extinguishing a fire by the handheld extinguishing equipment according to this example embodiment of the invention it has the following tested parameters. Pressurized water, coming out of the high-pressure water pump 2 according to the present invention and inletting through the inlet 6 into the inlet nozzle 19 firefighting nozzle 1, has pressure of 2 MPa. The prepared extinguishing mixture, coming out of adapter 9, has an outlet speed of 25 m·s⁻¹ and a maximum reach of about 20 m. In this example embodiment it is a light extinguishing mixture.

Light extinguishing mixtures are designated in particular for the extinguishing of fires in interiors, offices, apartments, hotels, where there is an increased need that the extinguishing medium contains as little water as possible. This particular example embodiment ranks as the third most efficient handheld fire extinguishing equipment according to the present invention.

### Example 3

### (FIG. 5.2)

Handheld Fire Extinguishing Equipment with a Firefighting Nozzle 1, Having an Outlet Channel 20 in the Shape of a Rotational Hyperboloid

FIG. 5.2 shows a firefighting nozzle 1 identical with the embodiment according to example 1 (FIG. 4), except for the structure of another alternative outlet channel 20, which is made in four stages 20e, 20f, 20g, 20h. The first stage 20e is cylindrical, of a constant diameter, bigger than the mixing chamber 12, to which the first stage 20e is linked. The other three stages 20f, 20g, 20h uninterruptedly linked to each other in the direction of flow have variable sections along the length of the longitudinal axis 21 of the firefighting nozzle 1, and as whole they have in the section the shape of a rotating body practically in the shape of a rotating hyperboloid in the direction of the longitudinal axis 21 of the firefighting nozzle 1. Each stage 20f, 20g, 20h in its section reminds of the “shape of a tulip”. In more detail, in the direction of flow and longitudinal axis 21 of the firefighting nozzle 1: the second stage 20f gets narrowed slightly into the narrowest section of the outlet channel 20, the third stage 20g gets slightly widened and the fourth stage 20f opens wide and is linked with its end most widened section to the section of the cylindrical chamber 22. The first two stages in length occupy 40% and the other two stages occupy about 60% in length in the direction of longitudinal axis 21 of the firefighting nozzle 1.

The fire extinguishing equipment according to this example embodiment works similarly like in the previous example embodiment, where the shape of a rotational hyperboloid in four stages 20e, 20f, 20g, 20h, as an alternative outlet channel 20, is the most efficient from the described examples of embodiment of the present invention, as shown by following practical tests. Constriction of the stage 20g into the narrowest section adds to the increase of pressure and speed of the extinguishing mixture. In this alternative outlet channel 20 the outlet extinguishing mixture is formed into the required quality of a very light extinguishing mixture.

When extinguishing a fire by the handheld extinguishing equipment according to this example embodiment of the invention it has the following tested parameters. Pressurized water, coming out of the high-pressure water pump 2 according to the present invention and inletting through the inlet 6 into the inlet water nozzle 19 firefighting nozzle 1, has pressure of 2 MPa. The prepared extinguishing mixture, coming out of the adapter 9, has an outlet speed of 36 m·s⁻¹ and a maximum reach of about 25 m. In this example embodiment it is a very light extinguishing mixture.

Very light extinguishing mixtures are designated in particular for the extinguishing of fires in interiors, offices, apartments, hotels where there is an increased need for the extinguishing medium to contain as little water as possible. This particular example embodiment represents the most efficient handheld fire extinguishing equipment according to the present invention.

### Example 4

### (FIG. 5.3)

Handheld Fire Extinguishing Equipment with a Firefighting Nozzle 1, Having an Outlet Channel 20 in the Shape of a Rotational Ellipsoid

FIG. 5.3 shows a firefighting nozzle 1 identical with the embodiment according to example 1 (FIG. 4), except for another alternative outlet channel 20i, which is made in the shape of a rotating ellipsoid, in the direction of longitudinal axis 21 of the firefighting nozzle 1. The alternative outlet channel 20i in the shape of a rotational ellipsoid is on the end adjacent to the outlet chamber 22 vertically ended with respect to the longitudinal axis 21 and is linked with this end section to the corresponding section of a cylindrical outlet chamber 22.

The fire extinguishing equipment according to this example embodiment works similarly like in the previous example embodiments, where the shape of a rotational ellipsoid 20i, as an alternative outlet channel 20, serves for the production of the heaviest extinguishing mixture, as shown by following practical tests.

When extinguishing a fire by the handheld extinguishing equipment according to this example embodiment of the invention it has the following tested parameters. Pressurized water, coming out of the high-pressure water pump 2 according to the present invention and inletting through the inlet 6 into the inlet water nozzle 19 of firefighting nozzle 1, has pressure of 2 MPa. The prepared extinguishing mixture, coming out of adapter 9, has an outlet speed of 12 m·s⁻¹ and a maximum reach of about 10 m. In this example embodiment it is a very heavy extinguishing mixture.

Very heavy extinguishing mixtures are suitable in particular for the extinguishing of fires in exteriors and outdoors, such as for the extinguishing of bins, surrounding greenery etc. where the extinguishing medium can contain more water, which will not cause so heavy material damage like in the interior.

### Example 5

### (FIG. 5.4)

Handheld Fire Extinguishing Equipment with a Firefighting Nozzle 1, Having an Outlet Channel 20 in the Shape of an Assembled Rotating Paraboloid

FIG. 5.4 shows a firefighting nozzle 1 identical with the embodiment according to example 1 (FIG. 4), except for another alternative outlet channel 20, in the shape of three stages 20j, 20k, 20i, continuously linked to each other and with variable continuous sections. As a whole, it corresponds to the shape of a two-part assembled rotating paraboloid, in the direction of the longitudinal axis 21 of the firefighting nozzle 1 and reminds of a “cup”. The extreme narrower section of paraboloid, on the side adjacent to the mixing chamber 12, represents the first part 20j. The extreme part of paraboloid situated on the opposite side, adjacent to the outlet chamber 22, is wider and represents the third stage 20l. In between these two extreme stages 20j, 20l into the narrowest section of the outlet chamber 20 the middle part, second stage 20k is aligned. The paraboloid between both extreme stages 20j, 20l, in approximately one fourth of length in the direction of flow and longitudinal axis 21, is constricted into the narrowest section of the middle part of the second stage 20k of the outlet channel 20.

The fire extinguishing equipment according to this example embodiment works similarly like in the previous example embodiment, where the alternative outlet channel 20 in the shape of a two-part assembled rotating paraboloid with three stages 20j, 2k, 20i, serves for the production of a heavy extinguishing mixture, as shown by following practical tests.

When extinguishing a fire by the handheld extinguishing equipment according to this example embodiment of the invention it has the following tested parameters. Pressurized water, coming out of the high-pressure water pump 2 according to the present invention and inletting through the inlet 6 of water into the inlet nozzle 19 of firefighting nozzle 1, has pressure of 2 MPa. The prepared extinguishing mixture, coming out of adapter 9, has an outlet speed of 16 m·s⁻¹ and a maximum reach around 14 m. In this example embodiment it is a heavy fire extinguishing mixture.

Heavy extinguishing mixtures are suitable in particular for the extinguishing of fires in exteriors and outdoors, such as for the extinguishing of bins, surrounding greenery etc. where the extinguishing medium can contain more water, which will not cause so large material damage like in the interior.

### Example 6

### (FIG. 5.5)

Handheld Fire Extinguishing Equipment with a Firefighting Nozzle 1, Having an Outlet Channel 20 in the Shape of a Simple Rotating Hyperboloid

FIG. 5.5 shows a vertical section of the firefighting nozzle 1 with an alternative outlet channel 20m in the shape of a “tulip-like” rotating simple hyperboloid in the direction of the longitudinal axis 21 of the firefighting nozzle 1.

The fire extinguishing equipment according to this example embodiment works similarly like in the example embodiment according to FIG. 5.2, where the shape of a simple rotating hyperboloid 20m, as an alternative outlet channel 20, is very efficient among the described examples of embodiments of the present invention, as shown by following practical tests. In this alternative outlet channel 20m the outlet extinguishing mixture is formed into the required quality of a light extinguishing mixture.

When extinguishing a fire by the handheld extinguishing equipment according to this example embodiment of the invention it has the following tested parameters. Pressurized water, coming out of the high-pressure water pump 2 according to the present invention and inletting through the inlet 6 of water into the inlet nozzle 19 of firefighting nozzle 1, has pressure of 2 MPa. The ready extinguishing mixture, coming out of the adapter 9, has an outlet speed of 28 m·s⁻¹ 1 and a maximum reach of about 23 m. In this example embodiment it is a very light extinguishing mixture.

Light extinguishing mixtures are designated in particular for the extinguishing of fires in interiors, offices, apartments, hotels where there is an increased need for the extinguishing medium to contain as little water as possible. This particular example embodiment represents an efficient handheld fire extinguishing equipment according to the present invention.

### Example 7

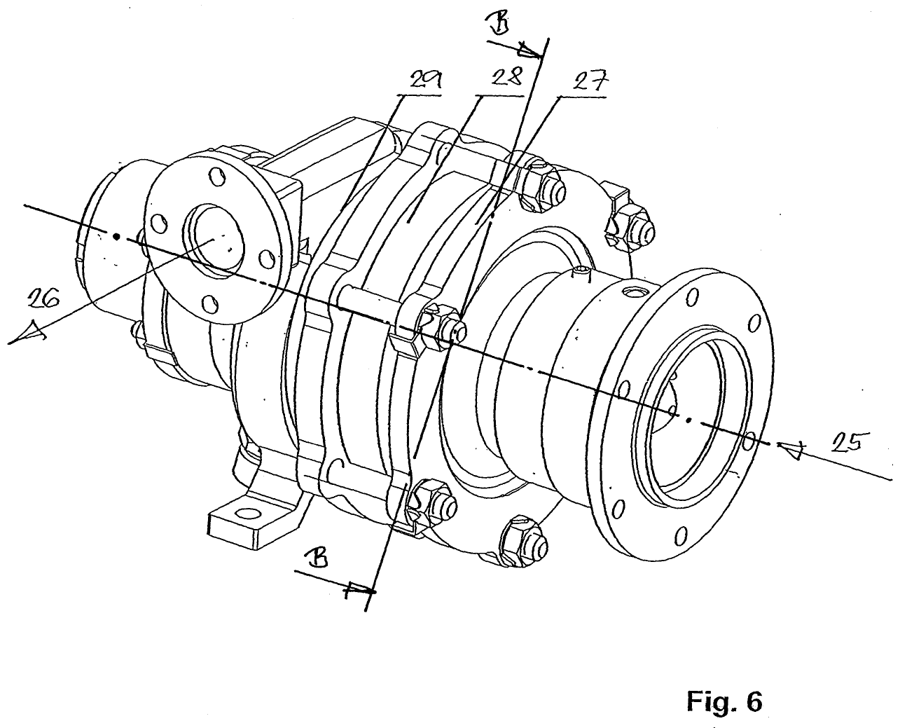

### (FIGS. 6, 7, 8, 9, 10, 11, 12)

### High-Pressure Water Pump 2

The high-pressure water pump 2, which is multistage, three-stage with an advantage, is fitted with turbine blade wheels 30 rotating around their axis, aligned one after another in the direction of the turning shaft 31 of the high-pressure pump 2. The high-pressure water pump 2 is fitted with separated firmly fixed spiral blades 30 radially aligned to the axis of shaft 31. The high-pressure water pump 2 was specifically developed and tested by the applicant for the purpose of the handheld fire extinguishing equipment with the firefighting nozzle 1 according to the present invention. Blades 32 have a different shape and a different angle of attack each, and are designed as a combination of partly open and partly closed wheel blades 30.

In the advantageous example embodiment the high-pressure water pump 2 has at 10 000 revolutions per minute, a displacement on the discharge 26 of water from the pump 2 of 1 (one) liter of pressurized water per 1 second at the pressure of 2 MPa and power of the electric engine 3 of 3.5 KW and voltage of 60 V.

FIG. 6 shows an axonometric side view of the high-pressure water pump 2. In the right part of FIG. 6 the supply 25 of water into the pump 2 from a water source 5 is marked. In the left part of FIG. 6 the discharge 26 of water from the pump 2 is marked, linked to an unshown inlet 6 of water into the firefighting nozzle 1. The high-pressure water pump 2 in the example embodiment is three-stage, with three stages 27, 28, 29, with the first stage 27, second stage 28 and third stage 29 of high-pressure water pump 2, in which the pressure of water gets increased in the direction from the supply 25 of water to the discharge 26 of water from the water pump 2 into an unshown inlet 6 of water into the firefighting nozzle 1.

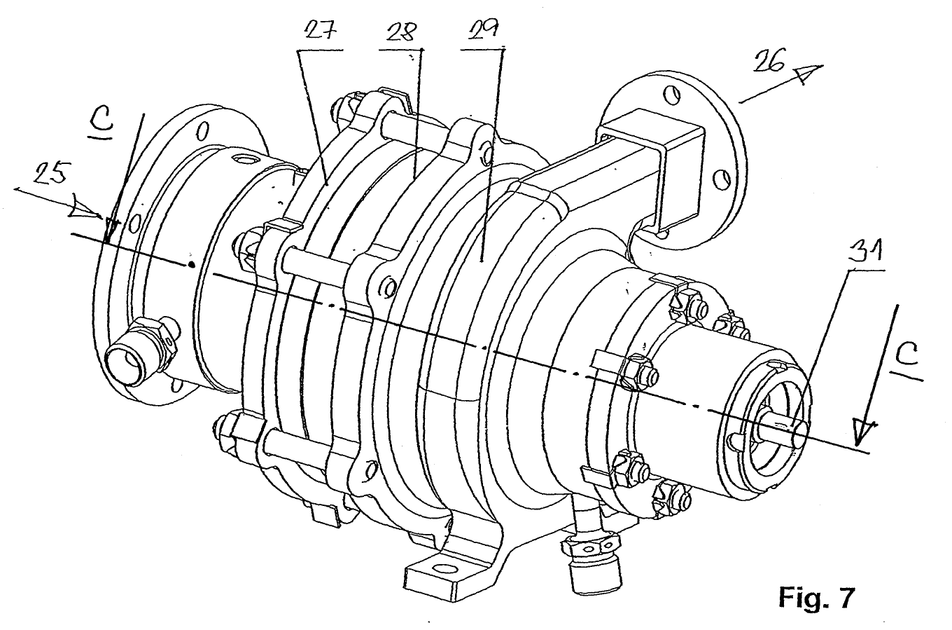

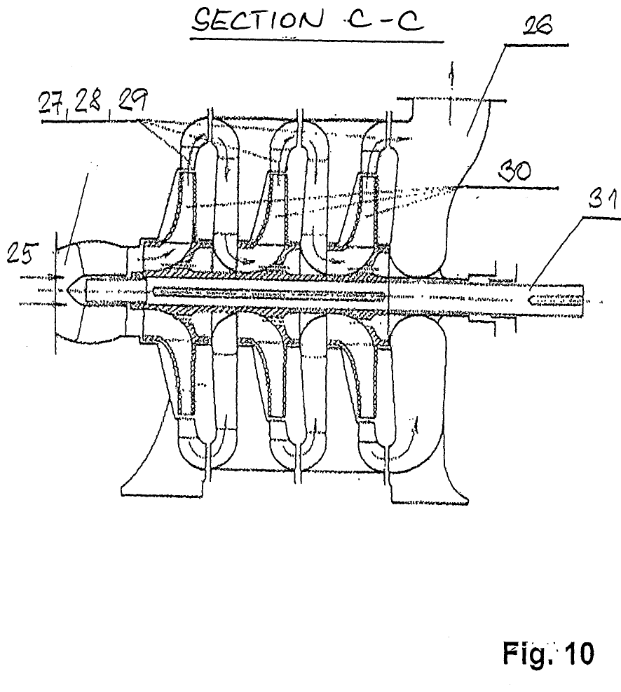

FIG. 7 shows an axonometric side view of the high-pressure water pump 2 with the supply 25 of water from the water source 5, in the left part of FIG. 7. In the upper part of FIG. 7 the discharge 26 of water from the high-pressure water pump 2 is shown into an unshown firefighting nozzle 1. On FIG. 10 in section C-C from FIG. 7, the individual stages 27, 28, 29 of the pump 2 and the turning shaft 31 of the pump 2 in its longitudinal axis are marked.

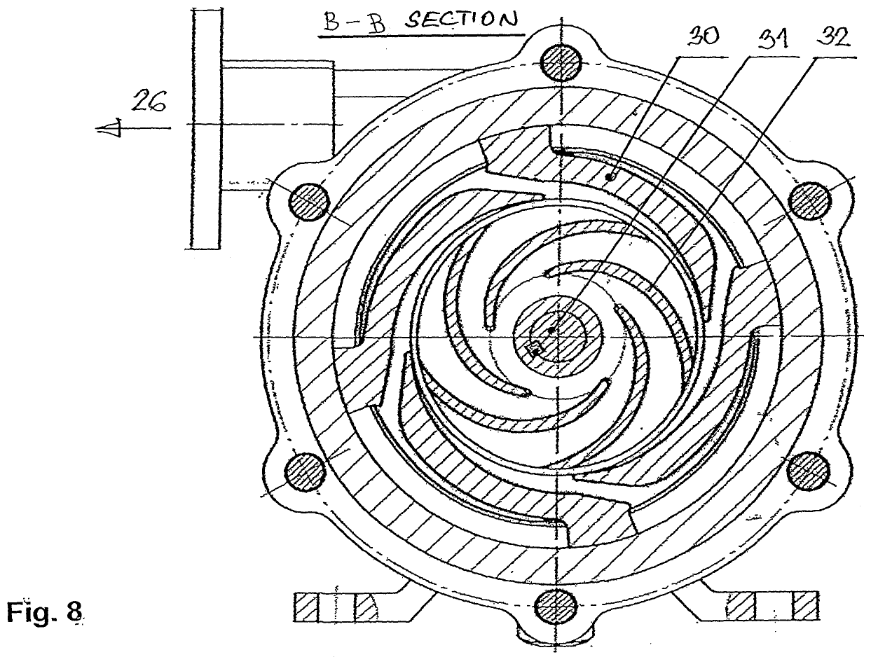

FIG. 8 shows the first turbine blade wheel 30 of the high-pressure water pump 2 in a front section B-B z FIG. 6. On FIG. 8 are shown also blades 32 of the turbine blade wheel 30, which are radially aligned to the central shaft 31. Blades 32 have a different shape and a different angle of attack each. Blades 32 are partly open and partly closed on the blade wheels 30. Spiral blades 32 are aligned in a three-stage alignment after each other in the direction of axis of the shaft 31.

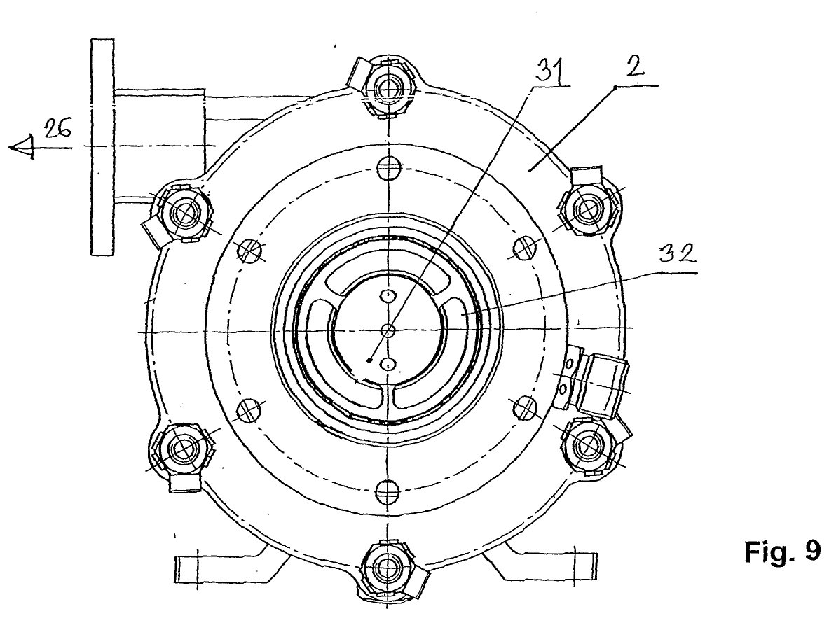

FIG. 9 shows a visual view through an orifice of the high-pressure water pump 2 from the side of an unshown supply 25 of water from the water source 5 from FIG. 6. Discharge 26 of water from the pump 2 is shown in the upper left part of FIG. 9. In FIG. 9 the shaft 31 of the pump 2 and the first turbine blade 32 of the turbine blade wheel 30 can be seen.

FIG. 10 shows a longitudinal vertical section C-C from FIG. 7 through the longitudinal axis of shaft 31. The arrows on the left mark the supply 25 of water from the water source 5 into the high-pressure water pump 2. The arrow on top marks the discharge 26 of water from the pump 2 into the firefighting nozzle 1. In the upper part above the shaft 31 the first stage 27, second stage 28 and third stage 29 of the high-pressure water pump 2 are shown. In the lower part under the shaft 31, three turbine wheel blades 30 of the high-pressure water pump 2 are marked in the example embodiment.

### INDUSTRIAL APPLICABILITY

The light, small and easy-to-control firefighting nozzle 1 of the handheld fire extinguishing equipment including a relatively small high-pressure water pump 2 and accumulator battery 4 is designated for the extinguishing of smaller fires in the interior and exterior, with the reach of extinguishing two-phase bubble-structured stream up to 25 m.

Instead of water as the liquid medium a standard foam mixture can be used.

### REFERENCE MARKS

1 firefighting nozzle
2 high-pressure water pump
3 electric engine
4 accumulator battery
5 source 5 of water
6 inlet 6 of water into the fire extinguishing equipment
7 outlet 7 of the extinguishing mixture
8 screw fitting 8 for the connection of a hose
9 adapter 9 of the firefighting nozzle 1
10 housing
11 air chamber,
12 mixing chamber
13 regulator 13 for the suction of outside air through the first suction orifices 14
14 first suction orifices for the intake of outside air into the mixing chamber 12
15 control handle
16 screw fitting 16 of the adapter 9
17 second suction orifices for the intake of outside air into the adapter 9
18 water chamber
19 inlet nozzle 19 for the inlet 6 of water
20 outlet channel
21 longitudinal axis 21 of the firefighting nozzle 1
22 outlet chamber
23 outlet partition 23 of the outlet chamber 22
24 outlet orifices 24 of the partition
20a first stage 20a of the outlet channel 20 from FIG. 4
20b second stage 20b of the outlet channel 20 from FIG. 4
20c third stage 20c of the outlet channel 20 from FIG. 4
20d truncated cone 20d of the outlet channel 20 from FIG. 5.1
20e first stage 20e of the outlet channel 20 from FIG. 5.2
20f second stage 20e of the outlet channel 20 from FIG. 5.2
20g third stage 20e of the outlet channel 20 from FIG. 5.2
20h fourth stage 20e of the outlet channel 20 from FIG. 5.2
20i ellipsoid outlet channel 20i from FIG. 5.3
20j first stage 20j of outlet channel 20 in the shape of a paraboloid from FIG. 5.4
20k second stage 20k of outlet channel 20 in shape of a paraboloid from FIG. 5.4
20l third stage 20l of outlet channel 20 in the shape of a paraboloid from FIG. 5.4
25 supply 25 of water from the water source 4 into the pump 25
26 discharge 26 of water from pump 25 into the extinguishing firefighting nozzle 5
27 first stage 27 of the pump 2
28 second stage 28 of the pump 2
29 third stage 29 of the pump 2
30 turbine blade wheel 30 of the pump 2
31 shaft 31 of the pump 2
32 blades 32 of the blade wheel 30 of the pump 2

1. The handheld fire extinguishing equipment for the generation of a two-phase bubble-structured stream includes a firefighting nozzle (1) and a high-pressure water pump (2) connected to an electric engine (3) and accumulator battery (4), where the firefighting nozzle (1) is connected by a fire hose to the high-pressure water pump (2), which is connected to a source (5) of water;
the firefighting nozzle (1) is fitted with a water chamber (18) with an inlet (6) of water through a conical convergent inlet nozzle (19), an air chamber (11) with the supply of outside air, connected to a mixing chamber (12) for the mixing of water and air and an adapter (9) with the outlet (7) of a two-phase bubble-structured extinguishing stream;
all chambers (11, 12 18), inlet nozzle (19), adapter (9) of the fire-fighting nozzle (1) are rotationally symmetrically aligned around the main longitudinal axis (21) of the fire nozzle (1);
characterized in that
the firefighting nozzle (1) includes:
the first suction orifices (14), which are aligned along the perimeter of mixing chamber (12) for the supply of regulatable outside atmospheric air into the mixing chamber (12), are through the regulator (13) of intake outside air connected with the air chamber (11), connected to the mixing chamber (12),
the second suction orifices (17), for the supply regulatable outside atmospheric air into the outlet adapter (9), are situated along the perimeter of the adapter (9) immediately behind the outlet partition (23) of outlet chamber (22),
the mixing chamber (12), which is on one end connected to a narrower end of the conical water inlet nozzle (19), connected through the water chamber (18) to the inlet (6) of water, and on the opposite end, the mixing chamber (12) is connected to the outlet channel (20) linked to the outlet chamber (22),
the outlet chamber (22), fitted perpendicularly to the direction of longitudinal axis (21) of the firefighting nozzle (1), with an outlet partition (23) fitted with outlet orifices (24).

2. The handheld fire extinguishing equipment according to claim 1,
characterized in that
the first suction orifices (14) of mixing chamber (12) are shaped as small cylindrical channels placed perpendicularly to the longitudinal axis (21) of firefighting nozzle (1) identical with the axis of mixing chamber (12) and linked to the air chamber (11), which is connected with the regulation orifice of regulator (13), placed in the housing (10) of the firefighting nozzle (1).

3. The handheld fire extinguishing equipment according to claim 1, characterized in that
the second suction orifices (17), which are shaped like small cylindrical channels, are aligned along the perimeter of screw fitting (16) of the adapter (9) and parallelly to the axis of firefighting nozzle (1), where the screw fitting (16) is a regulatable element for the intake quantity of ambient air into the adapter (9).

4. The handheld fire extinguishing equipment according to claim 1, characterized in that
the outlet channel (20) has a variable section, which is symmetrically rotationally aligned to the longitudinal axis (21) of firefighting nozzle (1), and which is in the direction of flow always bigger on the end of the outlet channel (20) adjacent to the outlet chamber (22) than the section in the beginning of the outlet channel (20) adjacent to the mixing chamber (12), where
the section of outlet channel (20) is selected from the group, containing the shapes of a truncated cone, composed truncated cones, rotating ellipsoid, rotating paraboloid and rotating hyperboloid.

5. The handheld fire extinguishing equipment according to claim 1, characterized in that
the outlet chamber (22) is cylindrical or conically narrowing in the direction of flow.

6. The handheld fire extinguishing equipment according to claim 1, characterized in that
the outlet partition (23) is planar, its outlet orifices (24) are cylinder-shaped and are oriented in the direction of longitudinal axis (21) of the firefighting nozzle (1), or
the outlet partition (23) is convex, its outlet orifices (24) are cylinder-shaped and are beveled to the longitudinal axis (21) of firefighting nozzle (1) in the range from 30° to 60°.

7. The handheld fire extinguishing equipment according to any of the prior claims 1 to 6, characterized in that
including multiple-stage high-pressure water pump (2), three-stage with an advantage, is fitted with turbine blade wheels (30) rotating around their axis, aligned one after each other in the direction of the turning shaft (31) of the pump (2) and fitted with separate firmly fixed spiral blades (32) radially aligned to the axis of turning shaft (31),
the blades (32) have a different shape and a different angle of attack each and are designed as a combination of partly open and partly closed blade wheels (30).

8. The handheld fire extinguishing equipment according to claim 7, characterized in that
the high-pressure water pump (2) at 10 000 revolutions per minute, has a displacement on the outlet (26) from the pump (2) of 1 liter of pressurized water per 1 second and pressure of 2 MPa and power of the electric engine (3) of 3.5 kW and voltage of 60 V.

9. The handheld fire extinguishing equipment according to any of the previous claims 1 to 8, characterized in that
the pressurized water, coming out of the high-pressure water pump (2) and inletting through the inlet (6) into the inlet nozzle (19) of firefighting nozzle (1), has pressure of 2 MPa, where the extinguishing stream on the outlet (7) of adapter (9) of the firefighting nozzle (1) of fire extinguishing equipment has an outlet speed up to 36 m·s⁻¹ and maximum reach of 25 m.

10. The method of extinguishing in the handheld fire extinguishing equipment for the generation of a two-phase bubble-structured flow, coming out from the outlet (7) of firefighting nozzle (1) of the fire extinguishing equipment, according to claims 1 to 9, during the extinguishing air and pressurized water are first led into the mixing chamber (12), and in the mixing chamber (12) they get mixed into a two-phase flow of air and drops of water, the generated two-phase flow of air and water behind the mixing chamber (12) forms a two-phase bubble-structured stream of droplets of water and bubbles of air in the range of sizes of drops from 10 to 300 μm, then it goes through the outlet elements with outlet orifices (24) into the ambient environment, where the volume concentration of air in the mixing chamber (12) is bigger than 0.523;
characterized in that
behind the mixing chamber (12) on the inlet into the outlet channel (20) the two-phase flow of air and water has a volume structure of air with drops of water, where the volume concentration of air is bigger than 0.523; and
the two-phase bubble-structured flow on the outlet from the widened end part of the outlet channel (20) has a volume structure of droplets of water and bubbles of air, where the volume concentration of air is lower than 0.523.

11. The method of extinguishing according to claim 10, characterized in that
from the high-pressure water pump (2) into the convergent conical nozzle (19) and from there into the mixing chamber (12) pressurized water under the pressure of 2 MPa±0.3 MPa and of the quantity of 60±10 liters per minute is led on a regulated basis;
this pressurized water suctions on a regulated basis the ambient atmospheric air without pressure through the first suction orifices (14) into the mixing chamber (12), in which air and water get mixed into the mixture of a two-phase flow of air and drops of water;
the obtained stream of air and drops of water behind the mixing chamber (12) gets reformed into a two-phase bubble-structured flow of droplets of water and bubbles of air by passing through the indent sections of outlet elements of the firefighting nozzle (1); where
into the outlet adapter (9) outside air is suctioned on a regulated basis through the outlet orifices (24) of the outlet partition (23); and
the generated two-phase flow of a turbulent character and bubble structure of dispersed drops of sizes 10 to 300 μm comes out of the outlet (7) from the firefighting nozzle (1) of the fire extinguishing equipment to the place of fire at the speed of up to 36 m·s⁻¹ and maximum reach up to 25 m.
